(19) United States
(12) Patent Application Publication
(10) Pub. No.: US 2009/0039627 A1
(43) Pub. Date: Feb. 12, 2009

(54) Side collision airbag device

(75) Inventor: Masatoshi Yokota, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 12/153,921

(22) Filed: May 28, 2008

(30) Foreign Application Priority Data
Aug. 9, 2007 (JP) 2007-207689

(51) Int. Cl. B60R 21/20

(52) U.S. Cl. 280/730.2

(57) ABSTRACT

A side collision airbag device includes a side collision airbag that inflates and extends between a side wall portion of a body of a vehicle and an occupant seated on a seat disposed in the body, and an inflator that spouts a gas from a spouting portion. The gas inflates and extends the side collision airbag. A tubular base cloth member is provided so as to cover the spouting portion and is folded in a form of accordion or pleats when the inflator is not activated. A shape holding cloth holds the tubular base cloth member in the vicinity of the spouting portion.

### BACKGROUND OF THE INVENTION AND RELATED STATEMENT

A side collision airbag device is known that inflates a side collision airbag at a side of an occupant by an inflator and restrains the body of the occupant upon a side collision, a vehicle body rolling, or the like of a vehicle such as an automobile. The side collision airbag device is, for example, embedded in a back portion of a seat, and upon the side collision or the like, the side collision airbag inflates and extends from the back portion in the space between the occupant and a side wall portion of the vehicle body by a gas injected from the inflator.

In the side collision airbag as mentioned above, a need arises, wherein the chamber pressure when inflated and extended is to be regulated, and extension behavior when inflated and extended is to be appropriately controlled. In such a case, it is required to regulate a gas flow from the inflator.

Hitherto, Japanese Unexamined Patent Application Publication No. 2005-225273 (Patent Document 1) describes a side collision airbag device having a gas-flow regulating means as mentioned above. In the conventional art, a tubular base cloth member (inner tube) is provided on the spouting port side of an inflator, and a gas spouted from the inflator is introduced to a lower side chamber, which supports a waist portion, thereby the lower side chamber is allowed to inflate earlier than an upper side chamber.

Further, in the conventional art described above, a basic configuration of the side collision airbag device is disclosed that is provided with the tubular base cloth member on the spouting port side of the inflator. On an occasion when the side collision airbag device is planned to be optimized, it is requested to facilitate an improvement of extension stability.

It is therefore an object of the present invention to provide a side collision airbag device, the extension stability of which can be improved.

Further objects and advantages of the invention will be apparent from the following description of the invention.

### SUMMARY OF THE INVENTION

To accomplish the above object, a side collision airbag device according to an embodiment of the present invention comprises a side collision airbag that inflates and extends in a space between a side wall portion of a body of a vehicle and an occupant being seated on a seat disposed in the body, an inflator that spouts a gas from a spouting portion thereof for inflating and extending the side collision airbag, a tubular base cloth member that is provided so as to cover the spouting portion and is folded in an accordion-like manner or in a roll-like manner when the inflator is not activated, and a holding member for holding the tubular base cloth member, which is folded in an accordion-like manner or in a roll-like manner in the vicinity of the spouting portion.

In the above embodiment, the tubular base cloth member is held by the holding member in the vicinity of the spouting portion of the inflator in a state of being folded in an accordion-like manner or a roll-like manner when the inflator is not activated. Then, when the inflator is activated, the folded tubular base cloth member extends by the pressure of the gas spouted from the spouting portion, and the gas flows into the inside of the airbag through the extended tubular base cloth member. By this, the side collision airbag inflates and extends in the space between the side wall portion of the body of the vehicle and the occupant being seated on the seat.

Accordingly, by holding the tubular base cloth member in the state of being folded in the accordion-like manner or the roll-like manner when the inflator is not activated, the tubular base cloth member is prevented from being irregularly pleated or wrinkled. Further, the extending motion of the tubular base cloth member when the inflator is activated can be made stable. As a result, the gas spouted from the inflator can be stably introduced into the inside of the airbag and the stability of extension speed of the airbag can be obtained. Consequently, the extension stability of the side collision airbag can be improved.

Further, according to another embodiment of the present invention, a tubular sleeve disposed as the spouting portion is provided so as to cover one side of the inflator in its longitudinal direction, i.e. the gas spouting side and having a throttle portion for reducing a flow of the gas spouted from the inflator, wherein the tubular base cloth member is provided so as to cover the sleeve.

In the above embodiment, a flow passage of the gas spouted from the inflator is narrowed by the throttle portion provided in the sleeve, which is disposed so as to cover the one side of the inflator in its longitudinal direction, i.e. the gas spouting side. By this, in the case that the side collision airbag has a plurality of partitioned chambers, for example, it becomes possible to regulate the flow of the gas supplied from the inflator to a particular one of the plurality of partitioned chambers. As the result, it becomes possible that a pressure ratio between the chambers when inflated and extended is adjusted and also that extension behavior of each chamber when inflated and extended is made different from the others.

Further, according to another embodiment of the present invention, the holding member has a tear portion for allowing the tubular base cloth member to extend when the inflator is activated.

In the above embodiment, when the inflator is activated, the folded tubular base cloth member is forced to be extended by the pressure of the gas spouted from the spouting portion, and the tear portion of the shape holding cloth for holding the tubular base cloth member is torn by the force, thereby the tubular base cloth member extends. Thus, by configuring the holding member to have the tear portion, it becomes possible that the tubular base cloth member quickly extends when the inflator is activated, while the tubular base cloth member is maintained in a state of being folded when the inflator is not activated.

According to another embodiment of the present invention, a side collision airbag that inflates and extends in a space between a side wall portion of a body of a vehicle and an occupant being seated on a seat disposed in the body, the side collision airbag including a plurality of partitioned chambers therein, an inflator that spouts a gas from one side thereof in a longitudinal direction for inflating and extending the side collision airbag, a sleeve disposed so as to cover the one side of the inflator in its longitudinal direction in a connection passage for connecting the plurality of chambers and having a throttle portion for reducing a flow of the gas spouted from the inflator, and a tubular base cloth member that is provided so as to cover the sleeve and is configured so that its projected length from the sleeve is at least equal to or more than the diameter of the sleeve when the inflator is activated.

In the above embodiment, when the inflator is activated, a gas, the amount of which is reduced by the throttle portion of the sleeve disposed so as to cover the one side of the inflator in its longitudinal direction, flows into a chamber on the one side through the tubular base cloth member, and a gas that is not allowed to pass through the throttle portion flows into a chamber on the other side through the connection passage. The gas spouted from the inflator is thus provided to the plurality of chambers, and thereby the side collision airbag inflates and extends in a space between the occupant and the side wall portion of the body of the vehicle. At that time, in the chamber on the one side, the tubular base cloth member is inflated by pressure of the gas spouted from the sleeve, and the gas flows into the inside of the airbag through the extended tubular base cloth member. Therefore, a tubular base cloth member having a shorter length extends at a faster speed, and the extension stability of the airbag can be improved.

On the other hand, in a side collision airbag having chambers that restrain a breast portion and a waist portion of an occupant, respectively, for example, when the pressure of a chamber of one side is set at a level higher than that of the pressure of a chamber of the other side as with when the pressure of a chamber for restraining the waist portion is set at a level higher than that of a chamber of the breast portion side from a point of view of safety improvement, it is required to prevent a gas from flowing back through a sleeve disposed in a connection passage when the airbag inflates and extends. According to the above embodiment of the present invention, when the gas flows back from the chamber on the one side to the chamber on the other side through the sleeve, the tubular base cloth member is folded to block the sleeve, thereby a back-flow is prevented.

At that time, the tubular base cloth member is configured in a manner such that a projected length from the sleeve when the inflator is activated is at least equal to or more than the diameter of the sleeve. By this, when the gas flows back from the chamber on the one side to the chamber on the other side through the sleeve when the airbag inflates and extends, the tubular base cloth member having the length equal to or more than the diameter of the sleeve is folded to block the sleeve with certainty. By this, it becomes possible to make the chamber on the one side at a higher pressure than the other chamber on the other side.

Further, by configuring the tubular base cloth member so that the projected length from the sleeve is at least equal to or more than the diameter of the sleeve, it becomes possible to obtain the extension stability of the airbag, while the prevention of the back-flow is ensured.

In a further embodiment of the present invention, the tubular base cloth member is extended toward the other side of the inflator in its longitudinal direction and has an elongated portion secured by a fixing member for fixing the inflator to a body side of the vehicle.

The elongated portion of the tubular base cloth member is secured by the fixing member for fixing the inflator to the body side of the vehicle and thereby the tubular base cloth member is fixed to the inflator. By this, any fixing member for securing the tubular base cloth member to a vehicle side is not required to be separately provided and the securing structure can be simplified. In addition, because the fixing member for securing the tubular base cloth member is not required, it becomes possible to restructure an existing side collision airbag device, which does not have a tubular base cloth member, so as to have a function of a check valve in a simple configuration by retrofitting a tubular base cloth member.

In another embodiment of the present invention, the elongated portion is sandwiched between the sleeve and a plate being overlapped on the sleeve at the position secured by the fixing member. Further, after the elongated portion of the tubular base cloth member is secured by the fixing member for fixing the inflator, at the secured position the elongated portion is further sandwiched between the sleeve and the plate overlapped thereon. By this, the tubular base cloth member can be secured to the inflator with certainty.

According to another embodiment of the present invention, the tubular base cloth member is formed in a substantially tubular shape by stitching side edges of a plane-shaped base cloth facing each other and is configured in a manner such that the direction of the stitched line diagonally intersects with mesh directions of the base cloth at predetermined angles.

Further, the base cloth strength of the tubular base cloth member at the stitched portion can be increased and the base cloth of the stitched portion can be prevented from being torn when the gas is spouted from the inflator. As the result, breakage of the tubular base cloth member when the inflator is activated can be prevented. There is also an effect that the tubular base cloth member is inhibited from fraying at its periphery edge.

According to the embodiments of the present invention, the extension stability of a side collision airbag device can be improved.

### BRIEF DESCRIPTION OF THE DRAWINGS

FIG. 1 is an overall perspective view of an inflator for inflating and extending a side collision airbag of an embodiment of the present invention;

FIG. 2 is a developed plan view of the side collision airbag of the embodiment of the present invention;

FIG. 3a and FIG. 3b are partial cross-section views of the spouting portion of the inflator, which show a state that a tubular base cloth member folded in an accordion-like manner is held by a shape holding cloth when the inflator is not activated;

FIG. 4 is an overall perspective view of the inflator including a sleeve for reducing a flow of a gas spouted from the inflator;

FIG. 5 is a perspective view of the tubular base cloth member provided with the shape holding cloth having a tear line at a substantially midpoint portion thereof;

FIG. 6 is a perspective view of a tubular base cloth member in another embodiment of the present invention; and

FIG. 7 is a partial cross-section view of a spouting portion of an inflator, which shows a state that the tubular base cloth member is held in the vicinity of the spouting portion of the inflator when the inflator is activated.

### DETAILED DESCRIPTION OF PREFERRED EMBODIMENTS

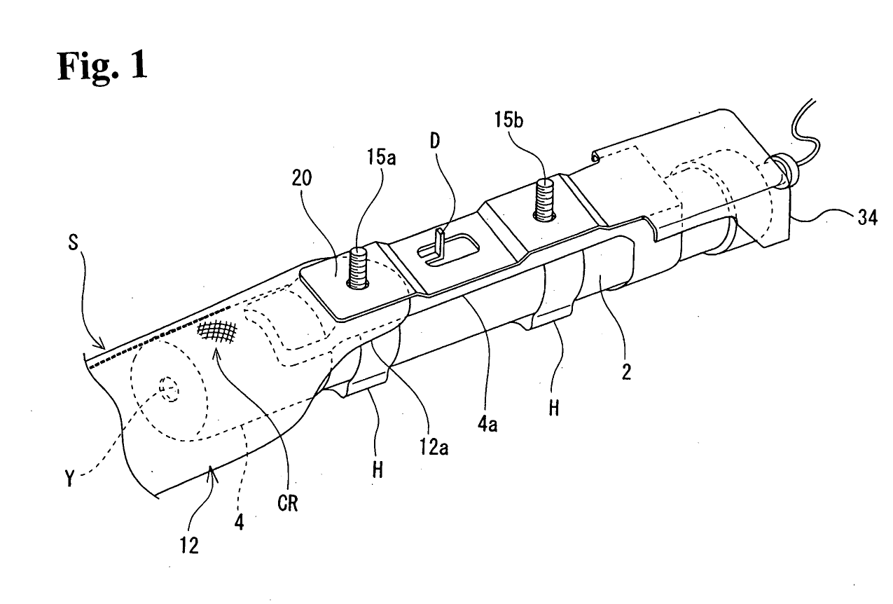

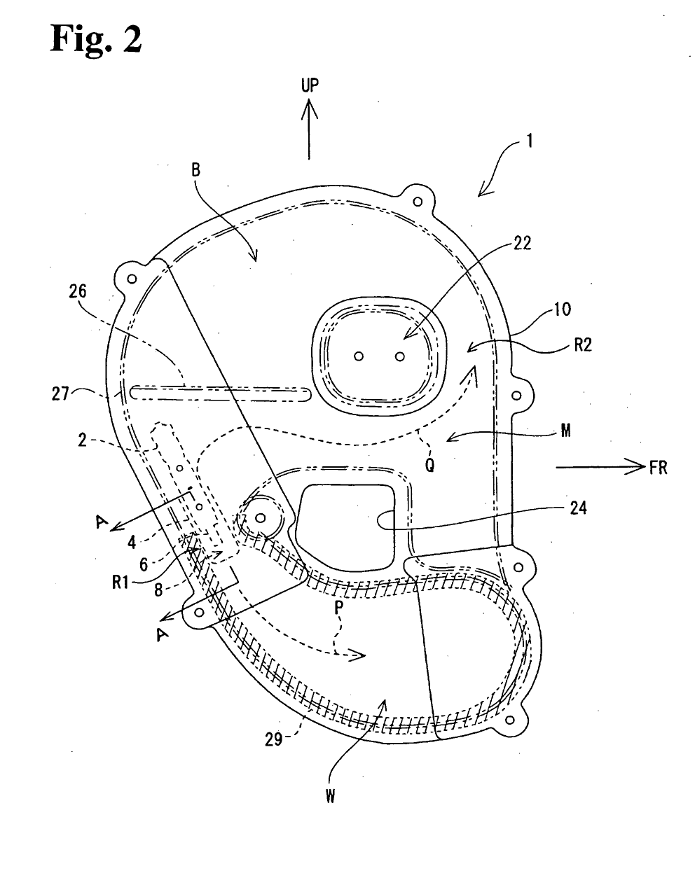

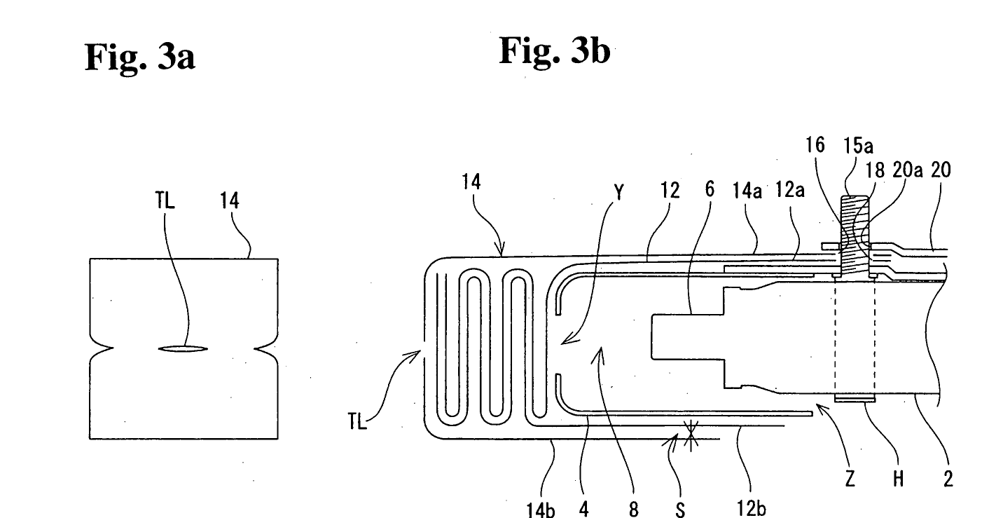

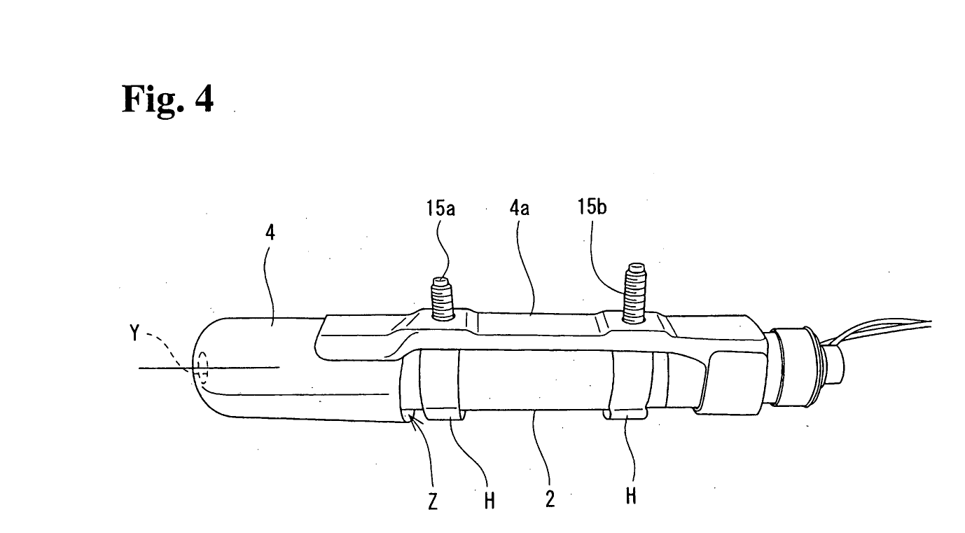

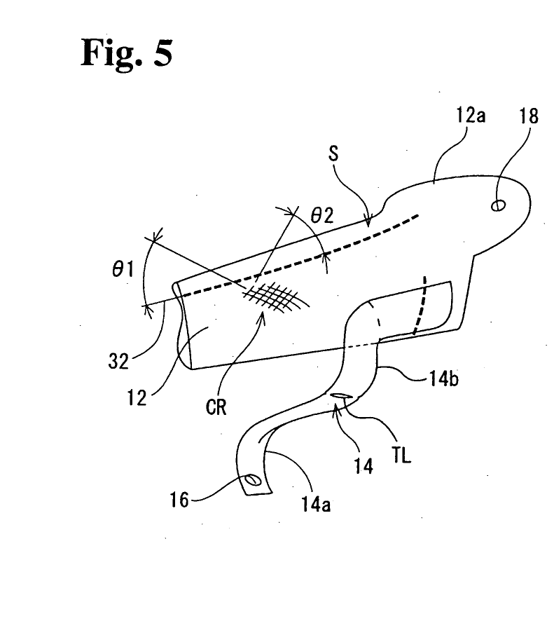

An embodiment of the present invention will now be described with reference to FIG. 1 through FIG. 5. FIG. 1 is an overall perspective view of an inflator for spouting a gas for inflating and extending a side collision airbag of this embodiment, FIG. 2 is a developed plan view of the side collision airbag, FIGS. 3 are partial cross-section views of the spouting portion of the inflator, taken along line A-A in FIG. 2, which show a state that a tubular base cloth member folded in an accordion-like manner is held by a shape holding cloth in the vicinity of the spouting portion of the inflator when the inflator is not activated, FIG. 4 is an overall perspective view of the inflator including a sleeve for reducing a flow of the gas spouted from the inflator, and FIG. 5 is a perspective view of the tubular base cloth member provided with the shape holding cloth having a tear portion at its substantially midpoint portion. Incidentally, to avoid complication, the shape holding cloth in FIG. 1 and the tubular base cloth member in FIG. 2 are not shown.

In the side collision airbag device 1 shown in FIG. 2, an arrow FR indicates a front side of a vehicle and an arrow UP indicates an upward direction of the vehicle. As shown in FIG. 1 to FIGS. 3, the side collision airbag device 1 consists of a bag-like side collision airbag 10 accommodated in a casing that is mounted to back portions of left and right front seats (not shown) disposed in a vehicle cabin, the back portions being on the sides of side wall portions (inner side portions of left and right doors) of the vehicle body, an inflator 2 for spouting a gas for inflating and extending the side collision airbag 10 from a spouting portion 8 (space between a projected portion 6 of the inflator and a sleeve 4 in this embodiment, see FIG. 1 and FIGS. 3), a tubular base cloth member 12 provided so as to cover the spouting portion 8 and folded in an accordion-like manner when the inflator 2 is not activated, and a shape holding cloth 14 (holding member) for holding the tubular base cloth member 12 folded in the accordion-like manner in the vicinity of the spouting portion 8.

On the other hand, the side collision airbag 10 is composed as a bag body by stitching base cloths along the entire perimeter and joining them together, the base cloths being formed in a substantially identical shape. Reference numeral 27 in FIG. 2 indicates the stitched and joined portion, which is double stitched in the part along the perimeter of the bag body (incidentally, the double stitch may be not necessarily required, but a single stitch may be allowed).

The interior of the side collision airbag 10 is sectioned by being stitched into a waist portion chamber W in its lower portion, which inflates and extends to a waist portion side of an occupant, a breast portion chamber B in its upper portion, which inflates and extends to a breast portion (shoulder portion) side of the occupant, and a middle chamber M in a portion between both the chambers W, B, the middle chamber M being partitioned from the breast portion chamber B at a position therebelow by a tether cloth 26, which is described later. In a connection passage R1 for connecting the middle chamber M and the waist portion chamber W, the inflator 2 is installed so that the spouting portion 8 faces the side of the waist portion chamber W (see FIG. 2).

Moreover, there are formed an opening 24 passing through the airbag in a vehicle width direction (direction vertical to the drawing in FIG. 2) between the waist portion chamber W and the middle chamber M of the side collision airbag 10, and a non-inflatable portion 22 between the breast portion chamber B and the middle chamber M. Due to this configuration, when the inflator 2 is activated, a gas flows into the waist portion chamber W from the spouting portion 8 (cf. dotted line arrow P in FIG. 2), the gas being regulated to be at a predetermined flow rate through a gas flow-out hole Y of the sleeve 4, and simultaneously a gas is guided to a front side in the middle chamber M from the spouting portion 8 by the tether cloth 26 and flows into the breast portion chamber B through a connection passage R2 for connecting the middle chamber M and the breast portion chamber B (see dotted line arrow Q in FIG. 2), the gas being regulated to be at a predetermined flow rate through a flow passage Z of the sleeve 4 (see FIG. 4).

Incidentally, of the stitched and joined portion 27, the portion constituting a periphery of the waist portion chamber W is provided with a sealing material portion 29 composed of an appropriate sealing material such as a silicone rubber or the like along the stitched and joined portion 27 for sealing thereof. The sealing material portion 29 is provided to be wider than the double stitched and joined portion 27 (see FIG. 2) so as to be able to seal both seams of the stitched and joined portion 27. By this, it becomes possible to improve the hermeticity of the waist portion chamber W and to maintain the pressure in the waist portion chamber W, which restricts movement of a waist portion of the occupant, in a high level for a long time.

Furthermore, in the side collision airbag device 1, the tubular base cloth member 12 shown in FIGS. 3 is held by the shape holding cloth 14 in the vicinity of the spouting portion 8 in a state of being folded in the accordion-like manner. Further, when the inflator 2 is activated, the folded tubular base cloth member 12 extends by the pressure of the gas spouted from the spouting portion 8 through the gas flow-out hole Y of the sleeve 4, and the gas flows into the inside of the side collision airbag 10 through the extended tubular base cloth member 12. By this, the side collision airbag 10 inflates and extends a space between the side wall portion of the vehicle body and the occupant being seated on the seat.

Incidentally, although not shown in particular, the tubular base cloth member 12 can be held by the shape holding cloth 14 in the vicinity of the spouting portion 8 in a state of being folded in a roll-like manner, besides being folded in the accordion-like manner.

The inflator 2 has the projected portion 6, on which a plurality of spouting holes (not shown) is formed, at its end portion on the side of the spouting portion 8. And, the tubular sleeve 4 having the gas flow-out hole Y (throttle portion) for reducing the flow of spouted gas is disposed so as to cover the projected portion 6 of the inflator 2, and the tubular base cloth member 12 is provided so as to cover the sleeve 4.

In detail, the tubular sleeve 4 has the gas flow-out hole Y at its tip, which is formed to face the projected portion 6 that spouts a gas from one side in a longitudinal direction (left side in FIG. 3b), and a spouted gas, the amount of which is regulated by this gas flow-out hole Y, flows into the waist portion chamber W. On the other hand, a spouted gas that is not allowed to pass through the gas flow-out hole Y flows out from an annular clearance Z formed by an outer periphery of the main body of the inflator 2 on one side in its longitudinal direction and the rim of an opening end on the other side (right side in FIG. 3b) of the above sleeve 4, the periphery of which is bigger than the above outer periphery, and flows into the middle chamber M. At that time, the outer periphery of the sleeve 4 and the sealing material portion 29 in a section of the connection passage R1 are kept in substantially intimate contact with each other, that is configured so that the spouted gas does not leak through a clearance between them. Thus, the flow rates of gas flowing from the inflator 2 into the side of the waist portion chamber W and the side of the middle chamber M (the breast portion chamber B) are divided at an appropriate ratio.

In addition, the shape holding cloth 14 is formed of a belt-like base cloth as shown in FIGS. 3 and FIG. 5, and configured so that its one end 14b is secured to one end 12b of the tubular base cloth member 12 by being stitched, while at the same time its other end 14a is secured by a bolt 15a, which is inserted through a securing hole 16 formed at the other end 14a, the bolt 15a at the spouting port side of bolts 15a, 15b of a pair of supporting members H disposed before and after of the inflator 2. Furthermore, a tear line TL (tear portion) is formed at a substantially midpoint portion of the shape holding cloth 14 in a direction crossing thereof, and when the inflator is activated, the shape holding cloth 14 is torn from this tear line TL and the tubular base cloth member 12 becomes extendable.

Moreover, the tubular base cloth member 12 is formed in a substantially tubular shape by stitching side edges of a plane-shaped base cloth facing each other at a stitch portion S as shown in FIG. 1 and FIG. 5, and has a securing piece 12a (elongated portion) in an end portion on the other side (right side in FIG. 1 and FIG. 5), the securing piece 12a being elongated toward the other side of the inflator 2 in its longitudinal direction (right side in FIG. 1 and FIG. 5). The securing piece 12a is secured by the bolt 15a, which is inserted through the securing hole 18 provided in the securing piece 12a. In addition, the other end 14a of the shape holding cloth 14, by which the tubular base cloth member 12 folded in the accordion-like manner is held by being wrapped from the outside, is overlapped on the securing piece 12a, and as described above, is secured by the bolt 15a, which is inserted through the securing hole 16. In this state, a stopper plate 20 is superposed above them and is secured by the bolt 15a, which is inserted through a securing hole 20a, thereby the securing piece 12a of the tubular base cloth member 12 and the other end 14a of the shape holding cloth 14 are sandwiched between the sleeve 4 (its supporting portion 4a, specifically see FIG. 4) and the stopper plate 20 (cf. FIG. 1 and FIGS. 3).

Additionally, the tubular base cloth member 12 is configured in a manner such that the direction of a stitch line 32 of the stitch portion S diagonally intersects with directions of cloth meshes CR of the base cloth at predetermined angles θ1, θ2, as shown in FIG. 5.

The stopper plate 20 (plate) includes a restricting portion 34, which is formed on the other side of spouting side of the inflator 2 (right side in FIG. 1) by being bent so as to cover a part of the end portion of the inflator 2, two bolt insertion holes 20a, 20b formed at positions corresponding to the bolts 15a, 15b, and a lug portion D formed by being cut and raised at a midpoint portion between these two insertion holes 20a, 20b.

The restricting portion 34 of the stopper plate 20 is for preventing the inflator 2 from moving toward a direction opposite to the gas spouting direction when a gas is spouted. And, the lug portion D is for enabling to confirm the lug portion D from the outside through a hole formed in a casing (not shown) for confirming a lug portion when the side collision airbag 10 is accommodated in the casing by being folded, and is also for preventing the stopper plate 20 from being forgotten to be attached.

In the next place, functional effects of the present embodiment constructed as described above will now be explained. That is, in the present embodiment, when the inflator 2 is not activated, the tubular base cloth member 12 is held in the vicinity of the spouting portion by the shape holding cloth 14 in a state of being folded in the accordion-like manner (or the roll-like manner), as described above. Then, when the inflator 2 is activated, the folded tubular base cloth member 12 is extended by the pressure of the gas spouted from the spouting portion 8, and the gas flows into the inside of the side collision airbag 10 through the extended tubular base cloth member 12. By this, the side collision airbag 10 inflates and extends a space between the side wall portion of the vehicle body and the occupant being seated on the seat.

By thus holding the tubular base cloth member 12 in a state of being folded in the accordion-like manner (or the roll-like manner) when the inflator 2 is not activated, it becomes possible that the tubular base cloth member 12 is prevented from being irregularly pleated or being wrinkled, and also that the extending motion of the tubular base cloth member 12 is made stable when the inflator 2 is activated. As the result, it becomes possible that the gas spouted from the inflator 2 is stably introduced into the side collision airbag 10 and the extension speed of the side collision airbag 10 is made stable. Consequently, the extension stability of the side collision airbag 10 can be improved.

Moreover, particularly in the present embodiment, a flow passage of the gas spouted from the inflator 2 is narrowed by the gas flow-out hole Y provided in the sleeve 4, which is disposed so as to cover the gas spouting side of the inflator 2. By this, the flow rate of gas provided from the inflator 2 to a specified chamber of a plurality of chambers can be regulated. As the results, it becomes possible that a pressure ratio between the chambers when inflated and extended is adjusted and also that extension behavior of each chamber when inflated and extended is made different from the others. Therefore, in the case that a side collision airbag 10 has a waist portion chamber W, a middle chamber M, and a breast portion chamber B as with the present embodiment, the inner pressure of the waist portion chamber W when inflated and extended can be raised more than the inner pressures of the middle chamber M and the breast portion chamber B.

Moreover, when the inflator 2 is activated, the folded tubular base cloth member 12 is forced to be extended by the pressure of the gas spouted from the spouting portion 8, and the tear line TL of the shape holding cloth 14 for holding the tubular base cloth member 12 is torn by the extension force, thereby the tubular base cloth member 12 is extended. By thus configuring the shape holding cloth 14 to have the tear line TL, it becomes possible that the tubular base cloth member 12 is held in a state of being folded when the inflator 2 is not activated, and also is quickly extended when the inflator 2 is activated.

Further, the securing piece 12a of the tubular base cloth member 12 is secured by the bolt 15a for securing the inflator 2 to the body side of a vehicle and thereby the tubular base cloth member 12 is fixed with respect to the inflator 2. By thus configuring the tubular base cloth member 12 to have the securing piece 12a, any fixing member for securing the tubular base cloth member 12 to the vehicle side is not required to be separately provided and the securing structure can be simplified. In addition, because the fixing member for fixing the tubular base cloth member 12 is not required, it becomes possible to restructure an existing side collision airbag device, which does not have the tubular base cloth member 12, so as to have a function of a check valve in a simple configuration by retrofitting a tubular base cloth member 12.

Further, after the securing piece 12a of the tubular base cloth member 12 is secured by the bolt 15a inserted therethrough, the securing piece 12a is further sandwiched between the sleeve 4 and the stopper plate 20 overlapped thereon at the secured position. By this, the tubular base cloth member 12 can be secured to the inflator 2 with certainty.

The tubular base cloth member 12 is configured in a manner such that the direction of a stitch line 32 of the tubular base cloth member 12 diagonally intersects with directions of cloth meshes CR of the base cloth composing the tubular base cloth member 12 at predetermined angles. By this, the base cloth strength of the tubular base cloth member 12 at the stitched portion can be increased and the base cloth of the stitched portion can be prevented from being torn when the gas is spouted from the inflator 2. As the result, breakage of the tubular base cloth member 12 when the inflator is activated can be prevented. There is also an effect that the tubular base cloth member 12 is inhibited from fraying at its periphery edge.

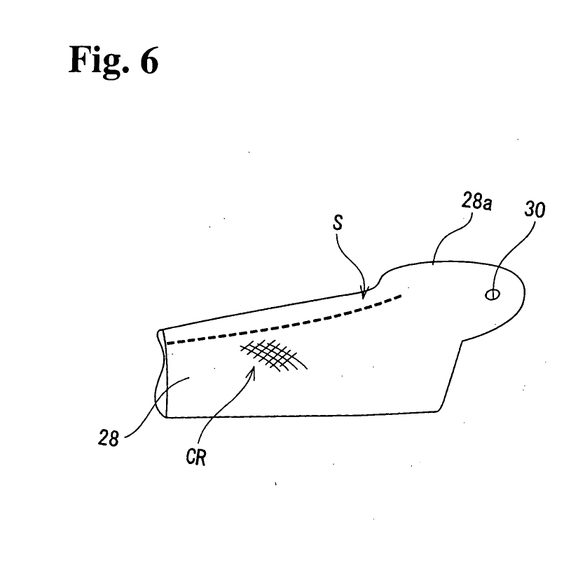

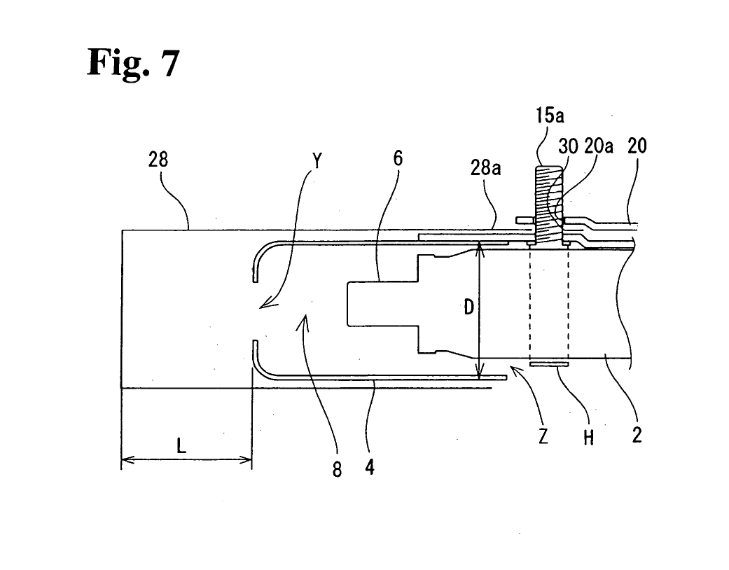

Incidentally, it is possible to use the tubular base cloth member 12 mounted in a state of being extended straight, but not being folded in the accordion-like manner (or the roll-like manner) as in an embodiment described above. An embodiment of this case will be described below with reference to FIG. 6 and FIG. 7.

FIG. 6 is a perspective view of a tubular base cloth member in another embodiment of the present invention, and FIG. 7 is a partial cross-section view of a spouting portion of an inflator, which shows a state that the tubular base cloth member is held in the vicinity of a spouting portion of the inflator when the inflator is activated. Incidentally, the same components as the above embodiments are indicated by the same reference characters, and repeated descriptions are omitted.

As shown in FIG. 6 and FIG. 7, the tubular base cloth member 28 of this embodiment is formed, as with the tubular base cloth member 12 described above, in a substantially tubular shape by stitching side edges of a plane-shaped base cloth facing each other at a stitch portion S, and has a securing piece 28a (elongated portion) in an end portion on the other side (right side in FIG. 6 and FIG. 7), the securing piece 28a being extended toward the other side (right side in FIG. 6 and FIG. 7) in a longitudinal direction of the inflator 2. The securing piece 28a is secured by a bolt 15a, which is inserted through a securing hole 30 provided in the securing piece 28a. Incidentally, since the tubular base cloth member 28 is not folded in this embodiment, a shape holding cloth 14 is not provided.

Besides, the tubular base cloth member 28 is configured in a manner such that a projected length L from an end portion of the sleeve 4 when the inflator 2 is activated is at least equal to or more than a diameter D of the sleeve 4 (cf. FIG. 7).

In the next place, functional effects of this embodiment constructed as described above will now be explained. That is, when the inflator 2 is activated, a gas, the amount of which is reduced by a gas flow-out hole Y of the sleeve 4 disposed so as to cover the spouting side of the inflator 2, flows into a waist portion chamber W through the tubular base cloth member 28, and a gas that is not allowed to pass through the gas flow-out hole Y flows into a breast portion chamber B through a middle chamber M. The gas spouted from the inflator 2 is thus provided to the plurality of chambers W, M, and B, and thereby the side collision airbag 10 inflates and extends in a space between an occupant and the side wall portion (inner side portions of left and right doors) of a vehicle body.

At that time, on the side of the waist portion chamber W on one side, the tubular base cloth member 28 is inflated and extended by the pressure of the gas spouted from the sleeve 4, and the gas flows into the inside of the waist portion chamber W through the extended tubular base cloth member 28. Therefore, the tubular base cloth member 28 having a shorter length L extends at a faster speed, and extension stability of the side collision airbag 10 can be improved.

On the other hand, in a side collision airbag 10 having chambers that restrain a breast portion and a waist portion of an occupant, respectively, as with this embodiment, when the pressure of the waist portion chamber W is set at a level higher than that of the breast portion chamber B from a point of view of safety improvement, it is required to prevent a gas from flowing back from the side of the waist portion chamber W to the side of the breast portion chamber B through the sleeve 4 disposed in a connection passage R, when the side collision airbag 10 inflates and extends.

In this embodiment, when the gas flows back from the side of the waist portion chamber W to the side of the breast portion chamber B on the other side through the sleeve 4, the tubular base cloth member 28 is folded, which causes the gas flow-out hole Y of the sleeve 4 to be blocked, and thereby the back-flow is prevented.

At that time, as described above, the tubular base cloth member 28 is configured in a manner such that the projected length L from the sleeve 4 when the inflator 2 is activated is at least equal to or more than the diameter D of the sleeve 4. By this, if the gas flows back from the side of the waist portion chamber W on one side to the side of the breast portion chamber B on the other side through the sleeve 4, when the side collision airbag 10 inflates and extends, the tubular base cloth member 28 having a length equal to or more than the diameter D of the sleeve 4 is folded, which causes the gas flow-out hole Y of the sleeve 4 to be blocked with certainty. By this, it becomes possible to keep the waist portion chamber W on one side at a higher pressure than the breast portion chamber B on the other side.

According to this embodiment, as in the above, by configuring the tubular base cloth member 28 so as to have a projected length L from the sleeve 4 at least equal to or more than the diameter D of the sleeve 4, it becomes possible to obtain the extension stability of the side collision airbag 10, while the prevention of a back-flow is ensured.

Incidentally, although the case that the flow of spouted gas is divided by providing the sleeve 4 on the spouting side of the inflator 2 is explained as an example in the above description, the sleeve 4 is not necessarily required to be provided in obtaining the effect of improvement of extension stability, which is a major functional effect of the present invention. That is, the present invention can be applied even in a case such that, for example, the side collision airbag has a two-chamber configuration having the waist portion chamber and the breast portion chamber, which are connected each other on a front side, allows the gas to flow into the waist portion chamber through the tubular base cloth member provided so as to cover the spouting portion 8 of the inflator 2 (the projected portion 6 of the inflator 2, in this case), and then allows the gas to flows into the breast portion chamber through a connection passage on the front side.

The disclosure of Japanese Patent Application No. 2007-207689 filed on Aug. 9, 2007 is incorporated herein as a reference.

While the invention has been explained with reference to the specific embodiments of the invention, the explanation is illustrative and the invention is limited only by the appended claims.

What is claimed is:

1. A side collision airbag device comprising:
a side collision airbag to be inflated and extended between a side wall portion of a body of a vehicle and a seat;
an inflator having a spouting portion, said inflator spouting a gas from the spouting portion for inflating and expanding the side collision airbag;
a tubular base cloth member arranged to cover the spouting portion, said base cloth being folded in a form of pleats or a roll when the inflator is not activated; and
a holding member for holding the tubular base cloth member folded in the form of pleats or roll, in a vicinity of the spouting portion.

2. The side collision airbag device according to claim 1, further comprising a tubular sleeve disposed so as to cover a spouting side of the inflator in a longitudinal direction thereof, and provided with a throttle portion for reducing a flow of the gas spouted from the inflator, the tubular base cloth member covering the sleeve.

3. The side collision airbag device according to claim 1, wherein the holding member has a tear portion allowing the tubular base cloth member to extend when the inflator is activated.

4. The side collision airbag device according to claim 1, wherein the tubular base cloth member extends toward the other side of the inflator in the longitudinal direction and has an elongated portion secured by a fixing member for fixing the inflator to the body of the vehicle.

5. The side collision airbag device according to claim 4, wherein the elongated portion is sandwiched between the sleeve and a plate at a position secured by the fixing member, the plate being overlapped on the sleeve.

6. The side collision airbag device according to claim 1, wherein the tubular base cloth member is formed in a substantially tubular shape by stitching opposing side edges of base cloths to each other and is configured in a manner such that the direction of the stitched line diagonally intersects with mesh directions of the base cloth at predetermined angles.

7. A side collision airbag device comprising:
a side collision airbag adapted to inflate and extend between a side wall portion of a body of a vehicle and a seat, the side collision airbag including a plurality of partitioned chambers therein and a connection passage for connecting the plurality of chambers;
an inflator having an elongated shape to spout a gas from one side in a longitudinal direction thereof, the gas inflating and expanding the side collision airbag;
a sleeve arranged to cover the one side of the inflator in the connection passage for connecting the plurality of chambers, said sleeve having a throttle portion for reducing a flow of the gas spouted from the inflator; and
a tubular base cloth member provided to cover the sleeve, and having a projected length from the sleeve at least equal to a diameter of the sleeve when the inflator is activated.

8. The side collision airbag device according to claim 7, wherein the tubular base cloth member extends toward the other side of the inflator in the longitudinal direction and has an elongated portion secured by a fixing member for fixing the inflator to the body of the vehicle.

9. The side collision airbag device according to claim 8, wherein the elongated portion is sandwiched between the sleeve and a plate at a position secured by the fixing member, the plate being overlapped on the sleeve.

10. The side collision airbag device according to claim 7, wherein the tubular base cloth member is formed in a substantially tubular shape by stitching opposing side edges of base cloths to each other and is configured in a manner such that the direction of the stitched line diagonally intersects with mesh directions of the base cloth at predetermined angles.
